(19) United States
(12) Patent Application Publication
(10) Pub. No.: US 2020/0218368 A1
(43) Pub. Date: Jul. 9, 2020

(54) WATERPROOF AND ANTI-FOULING MOUSE PAD

(71) Applicant: Hades-Gaming Corporation, New Taipei City (TW)

(72) Inventor: Hung-Jen CHOU, NEW TAIPEI CITY (TW)

(21) Appl. No.: 16/273,560

(22) Filed: Feb. 12, 2019

(30) Foreign Application Priority Data
Jan. 7, 2019 (TW) 108100588

(51) Int. Cl. G06F 3/039

(52) U.S. Cl. CPC G06F 3/0395; B32B 25/042

(57) ABSTRACT

A mouse pad structure includes a bottom pad, a second cloth and a first cloth. The bottom pad is a rubber pad of flat shape and has an upper surface and a lower surface located oppositely. The second cloth is attached on the upper surface. The first cloth is made of waterproof cloth and combined on the second cloth. Thus, the mouse pad can have effects of anti-fouling and waterproof.

### BACKGROUND OF THE INVENTION

### Field of the Invention

The present invention generally relates to mouse pad and, in particular to a waterproof and anti-fouling mouse pad.

### Description of Prior Art

Generally speaking, the use of a mouse pad is usually matched with a mouse to obtain an accurate mouse cursor position during the movement of the mouse. Moreover, the surface of current mouse pads can be made of a softer woven fabric to provide a comfortable and better touch for users on the operation of the mouse.

However, edges of the cloth surface of the mouse pad may have burrs due to the moving and touching of users after a long use, and even the mouse pad has a situation that the cloth surface may be lifted or separated from the mouse bottom pad which results in the product lacking of durability. Furthermore, when the user's hand moves over the surface of the mouse pad for a long time, the surface of the mouse pad may be soiled by the user's hand sweat or stained by foreign object. However, the mouse pad is not suitable for washing due to the cloth, and that will affect the appearance of mouse pad and mood of using.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a waterproof and anti-fouling mouse pad to achieve the purposes of anti-fouling and waterproofing.

In order to achieve the object mentioned above, the present invention provides a waterproof and anti-fouling mouse pad including a bottom pad, a second cloth, a first binding agent and a first cloth. The bottom pad is a rubber pad of flat shape and has an upper surface and a lower surface located oppositely. The second cloth is attached on the upper surface. The first binding agent is disposed on the middle pad. The first cloth is combined on the middle pad through the first binding agent.

Comparing to the prior art, the waterproof and anti-fouling mouse pad of the present invention includes a bottom pad, a second cloth, a first cloth and adhesive; besides, the binding force between the bottom pad and the first cloth surface is increased by the deposition of the second cloth to avoid separation and bubble generation therebetween so as to achieve a better binding effect and appearance, and that can increase the practicability of the present invention.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective explosion view of waterproof and anti-fouling mouse pad of the present invention;

FIG. 2 is a side view of combination of waterproof and anti-fouling mouse pad of the present invention;

FIG. 3 is a perspective explosion view of another embodiment of waterproof and anti-fouling mouse pad of the present invention;

FIG. 4 is a perspective schematic view of another embodiment of waterproof and anti-fouling mouse pad the present invention;

FIG. 5 is a side view of combination of another embodiment of waterproof and anti-fouling mouse pad of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

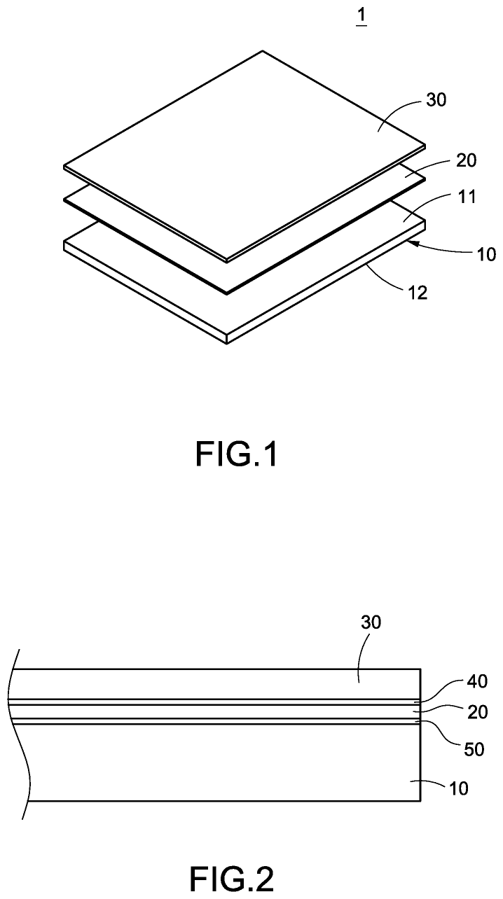

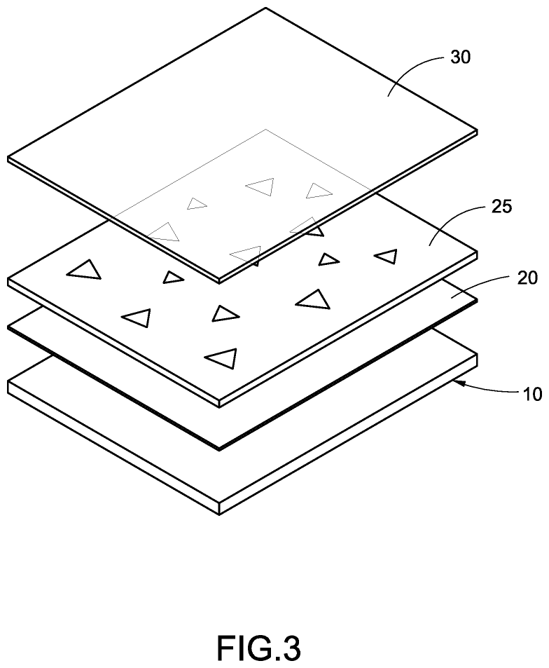

Please refer to FIG. 1 and FIG. 2, which depict a perspective explosion schematic view and a side view of combination of waterproof and anti-fouling mouse pad of the present invention. As shown in FIG. 1, the waterproof and anti-fouling mouse pad 1 of the present invention includes a bottom pad 10, a second cloth 20 and a first cloth 30. Moreover, the bottom pad 10, the second cloth 20 and the first cloth 30 are stacked sequentially to form the waterproof anti-fouling mouse pad 1.

Furthermore, in real practice, as shown in FIG. 2, the waterproof anti-fouling mouse pad 1 further includes a first binding agent 40 and a second binding agent 50. The first cloth 30, the second cloth 20 and the bottom pad 10 are combined together through the first binding agent 40 and the second binding agent 50. More detail descriptions of the waterproof anti-fouling mouse pad 1 are as follows.

The bottom pad 10 is a rubber pad of flat shape. The bottom pad 10 has an upper surface 11 and a lower surface 12 located oppositely. In the present embodiment, the bottom pad 10 is a rectangular piece, but the shape of the bottom pad 10 not limited to in real practice.

The second cloth 20 is attached on the upper surface 11. Preferably, the second cloth 20 is made of a woven fabric (such as a knitted fabric, a plain-woven fabric, etc.). It is worthy of notice that the bottom pad 10 can also directly bond the second cloth 20 after a heat press.

In addition, the first cloth 30 is made of a waterproof cloth such as Polyethylene (PE), Ethylene Vinyl Acetate (EVA), Polyvinyl Chloride (PVC), Polyurethane (PU) and other plastic materials. Besides, the first cloth 30 is combined on the second cloth 20, and the deposition of the first cloth 30 is provided for a mouse pad having effects of waterproof and anti-fouling in using. It is worthy of notice that the first cloth 30 can also be disposed as a common cloth, and the common cloth will become a waterproof cloth after some special treatment such as coating a waterproof material (for example GoreTex, fluorocarbon resin, Nano waterproof paint, etc.) thereon.

Specifically, please refer to FIG. 2, the first binding agent 40 is disposed between the second cloth 20 and the first cloth 30, and the second binding agent 50 is disposed between the second cloth 20 and the bottom pad 10. The first binding agent 40 and the second binding agent 50 are adhesive, and they are viscous when used as an adhesive.

It is worth mention that the bonding force between the bottom pad 10 made of rubber and the first cloth 30 is poor when combined through the binding agent, and bubbles are easily generated therebetween that affects the appearance. Therefore, the bottom pad 10 and the first cloth 30 in this embodiment are further combined through the deposition of the second cloth 20 for achieving a better binding effect and appearance.

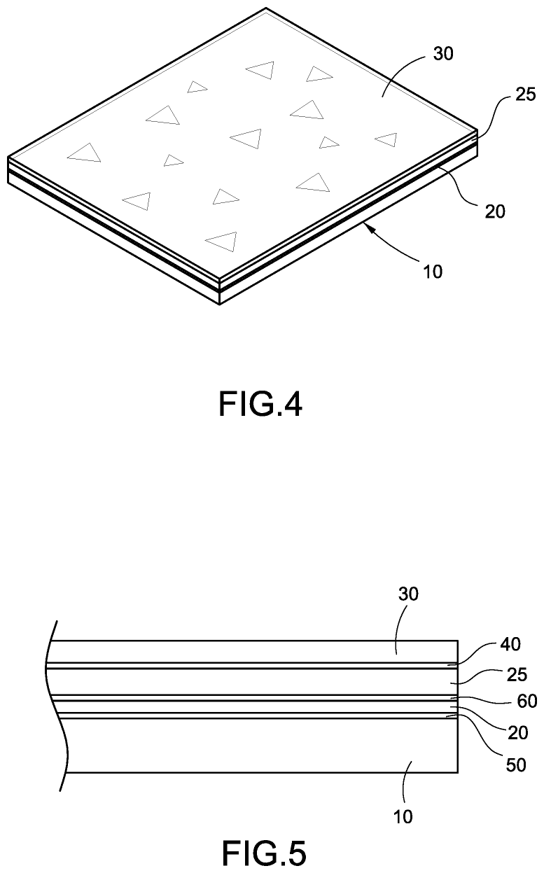

Please further refer to FIG. 3 to FIG. 5, which depict a perspective explosion schematic view, a perspective schematic view, and a side view of combination of another embodiment of waterproof and anti-fouling mouse pad of the present invention. With comparing to the previous embodiment, in the present embodiment, the waterproof and anti-fouling mouse pad 1 includes a bottom pad 10, a second cloth 20, a first cloth 30, a first binding agent 40 and a second binding agent 50, besides, the waterproof and anti-fouling mouse pad 1 further includes a middle pad 25 and a third binding agent 60.

The middle pad 25 is a rubber pad of flat shape, and the middle pad 25 is disposed on the second cloth 20. Further, the third binding agent 60 is disposed between the second cloth 20 and the middle pad 25; that is, the middle pad 25 is sandwiched between the second cloth 20 and the first cloth 30. In addition, the middle pad 25 is coupled to the second cloth 20 through the third binding agent 60 to configure the waterproof and anti-fouling mouse pad 1. Moreover, the structures of the bottom pad 10, the second cloth 20, the first cloth 30, the first binding agent 40, and the second binding agent 50 are the same as described above, and details are not described herein again.

It is worth mention that the middle pad 25 located between the second cloth 20 and the first cloth 30 is made of silicone rubber, and the deposition of the middle pad 25 can enhance the touch feeling of the waterproof anti-fouling mouse pad 1 when in use. In addition, since the first cloth 30 can be provided to be transparent, thus the color of the middle pad 25 can penetrate the first cloth 30. Therefore, the color and shape of appearance of the middle pad 25 can be changed so as to increase the practicability of the present invention.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

1. A waterproof and anti-fouling mouse pad, comprising:
a bottom pad being a rubber pad of flat shape; the bottom pad having an upper surface and a lower surface located oppositely;
a second cloth made of woven fabric being attached on the upper surface; and
a first cloth being made of a waterproof cloth and combined to the bottom pad through the second cloth.

2. The waterproof and anti-fouling mouse pad according to claim 1, wherein the bottom pad is combined with the second cloth by a heat press process.

3. The waterproof and anti-fouling mouse pad according to claim 1, further including a first binding agent, and the first binding agent is disposed between the second cloth and the first cloth.

4. The waterproof and anti-fouling mouse pad according to claim 3, wherein the first binding agent adheres to the second cloth and the first cloth and is viscous.

5. The waterproof and anti-fouling mouse pad according to claim 1, further including a second binding agent, and the second binding agent is disposed between the second cloth and the bottom pad.

6. The waterproof and anti-fouling mouse pad according to claim 5, wherein the second binding agent adheres to the second cloth and the bottom pad and is viscous.

7. A waterproof and anti-fouling mouse pad, comprising:
a bottom pad being a rubber pad of flat shape; the bottom pad having an upper surface and a lower surface located oppositely;
a second cloth made of woven fabric being attached on the upper surface;
a middle pad being a rubber pad of flat shape and disposed on the second cloth, wherein the middle pad is combined to the bottom pad through the second cloth;
a first binding agent disposed on the middle pad; and
a first cloth combined on the middle pad through the first binding agent.

8. The waterproof and anti-fouling mouse pad according to claim 7, wherein the bottom pad is combined with the second cloth by a heat press process.

9. The waterproof and anti-fouling mouse pad according to claim 7, further including a second binding agent, wherein the second binding agent is disposed between the second cloth and the bottom pad.

10. The waterproof and anti-fouling mouse pad according to claim 7, further including a third binding agent, wherein the third binding agent is disposed between the second cloth and the middle pad.
